(19) United States
(12) Patent Application Publication
(10) Pub. No.: US 2009/0102584 A1
(43) Pub. Date: Apr. 23, 2009

(54) Multiple Axis Transmission System

(76) Inventors: Prashant Sudhakar Zende, Bangalore (IN); Manuel Meana Alcon, Madrid (ES); Ronjit Monohar Deshmukh, Bangalore (IN); Victor Elviro, Madrid (ES); Ranganath Gururaj, Bangalore (IN); Jorge Juan Bonilla Hernandez, Madrid (ES); Javier Gomez Martin, Madrid (ES); Miguel Aguirre Trigo, Madrid (ES)

Correspondence Address: General Electric Company;GE Global Patent Operation, PO Box 861, 2 Corporate Drive, Suite 648, Shelton, CT, 06484, US

(21) Appl. No.: 11/877,108

(22) Filed: Oct. 23, 2007

(51) Int. Cl. H01H 77/00

(52) U.S. Cl. 335/10

(57) ABSTRACT

An interface module is configured for transmitting a status change signal between a first circuit device that has a first circuit device couple and a second circuit device that has a second circuit device couple. The interface module may include a housing, a first coupling assembly that includes a first couple arm and a second coupling assembly that includes a second couple arm. Each of the first and second couple arms extends through the housing at a location that is spaced from the other and each of the first and second coupling assemblies is movable by the first circuit device couple and/or the second circuit device couple to transmit a status change signal there between.

### BACKGROUND

1. Field

The subject matter described herein relates generally to devices and methods for circuit breaker assemblies and, more particularly, to coupling circuit breaker components.

2. Related Art

Conventional circuit breakers may include accessory devices that are either included within the housing of the circuit breaker or attached in tandem with the circuit breaker. For example, conventional side-by-side, ganged miniature circuit breakers may have a first enclosure including the circuit breaker trip elements and a second enclosure including an accessory function of the miniature circuit breaker. A trip shaft extends from the first enclosure and is received within an in-line receiver of the second enclosure. When the trip bar is activated in the first enclosure, movement of the trip bar activates the accessory function of the second enclosure. Other conventional circuit breakers including an accessory function include molded cases having accessory socket openings for coupling an accessory with an operating mechanism of the circuit breaker. Still other conventional circuit breakers having an accessory function include U-shaped accessory actuator clips that snap onto the crossbar of a multipole circuit breaker. The U-shaped accessory clip as well as the accessory are located within a primary cover of the circuit breaker.

However, to date, no suitable device or method is available for coupling, for example, a circuit breaker with an accessory in a tandem arrangement where a signal transmission axis of the circuit breaker is not aligned with a signal transmission axis of the accessory.

### BRIEF DESCRIPTION OF THE EMBODIMENTS

In accordance with one embodiment, an interface module is configured for transmitting a status change signal between a first circuit device that has a first circuit device couple and a second circuit device that has a second circuit device couple. The interface module may comprise a housing, a first coupling assembly that comprises a first couple arm and a second coupling assembly that comprises a second couple arm. Each of the first and second couple arms extends through the housing at a location that is spaced from the other and each of the first and second coupling assemblies is movable by the first circuit device couple and/or the second circuit device couple to transmit a status change signal there between.

In another aspect of the present invention, a circuit assembly comprises a first circuit device having a first circuit couple, a second circuit device having a second circuit device couple and an interface module adjacent to the first circuit device and the second circuit device. The interface module may comprise a housing, a first coupling assembly comprising a first couple arm and a second coupling assembly comprising a second couple arm. Each of the first and second couple arms extends through the housing at a location that is spaced from the other and each of the first and the second coupling assemblies is movable by the first circuit device couple and/or the second circuit device couple to transmit a status change signal there between.

### BRIEF DESCRIPTION OF THE DRAWINGS

The following detailed description is made with reference to the accompanying drawings, in which:

FIG. 1A is a schematic side view of an assembly in accordance with one embodiment;

FIG. 1B is a is an exploded, schematic top view of an assembly in accordance with an embodiment;

FIG. 2 is an exploded, perspective view of an assembly in accordance with the embodiment of FIG. 1B;

FIG. 3 is an exploded view of a portion of an assembly in accordance with an embodiment of FIG. 1B;

FIG. 3A is an enlarged portion of FIG. 3 showing a connector of the assembly of FIG. 1B;

FIG. 3B is an enlarged portion of FIG. 3 showing a connector module of the assembly of FIG. 1B;

FIG. 4 is a sectional view of an interface in a first configuration in accordance with an embodiment;

FIG. 5 is a sectional view of the interface of FIG. 4 in a second configuration in accordance with an embodiment;

FIG. 6 is a sectional view of an interface in a first configuration in accordance with an embodiment;

FIG. 7 is a sectional view of the interface of FIG. 6 in a second configuration in accordance with an embodiment;

FIG. 8 is a sectional view of an interface in a first configuration in accordance with an embodiment;

FIG. 9 is a sectional view of the interface of FIG. 8 in a second configuration in accordance with an embodiment;

FIG. 10 is another sectional view of the interface of FIG. 4 in a third configuration in accordance with an embodiment; and

FIG. 11 is a schematic diagram showing more details of the assembly of FIG. 2.

### DETAILED DESCRIPTION OF THE PREFERRED EMBODIMENTS

In one embodiment, a device and a method for coupling a circuit breaker and a circuit breaker accessory is provided. Although the embodiments disclosed will be described with reference to the drawings, it should be understood that the embodiments disclosed may be embodied in many alternate forms. In addition, any suitable size, shape or type of elements or materials could be used.

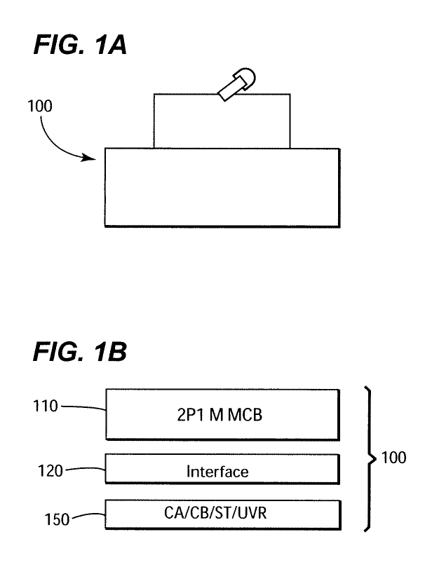

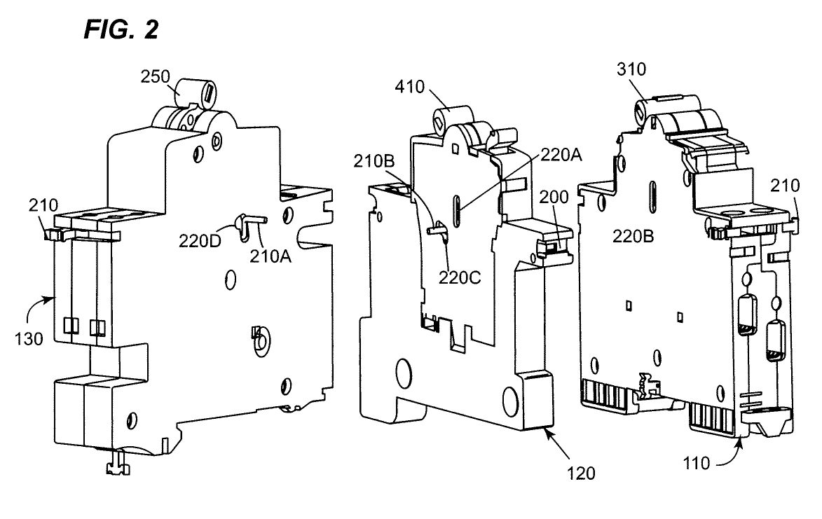

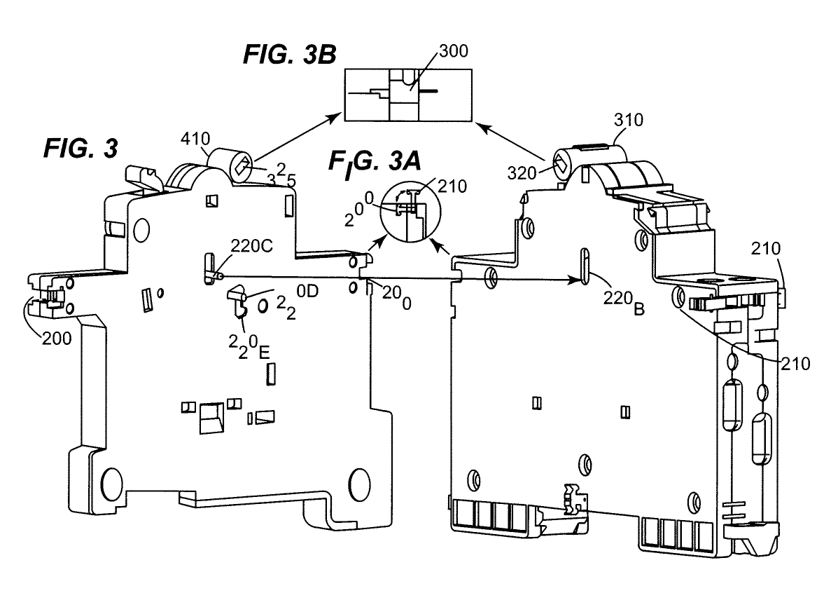

Referring now to FIGS. 1A and 1B, schematic illustrations of a side view (FIG. 1A) and top view (FIG. 1B) of a tandem circuit breaker assembly is shown generally at 100 in accordance with one embodiment. In this embodiment, the circuit breaker assembly 100 comprises a circuit breaker module 110, an interface module 120 and an accessory module 130. In alternate embodiments any suitable number and types of modules may be included in the assembly 100. The circuit breaker module 110 may include, but is not limited to, a miniature circuit breaker or any other suitable circuit or circuit interruption device. The accessory module may include, but is not limited to, one or more of a circuit assembly, a circuit breaker, a shunt trip, an under voltage release or any other suitable circuit or circuit interruption device. Referring also to FIGS. 2 and 3 exploded views of the circuit breaker assembly 100 are shown. In one embodiment, each of the modules 110, 120, 130 may be communicably coupled to each other through any suitable number of slots or apertures 200 and mating connectors 210. The connectors 210 may swivel and snap into the slots 200 as shown in FIG. 3A. In alternate embodiments, any suitable coupling device(s) may be utilized to couple the modules 110, 120, 130 together, such as for example, mechanical fasteners, adhesives and/or chemical fasteners. The switch handles 250, 310, 410 may also be coupled together so the handles move together as a unit. In one embodiment a connector module 300, as shown in FIG. 3B, may connect the handles 250, 310, 410. The handles 250, 310, 410 may have recesses, e.g., 320, 325 for use in being engaged together whereby the handles move as a unit. In other embodiments, one handle may have a protrusion that is accepted by or engages a recess in another handle for coupling the handles together. In alternate embodiments, the handles may be coupled together by a handle tie. In still other alternate embodiments the handles may be coupled to each other in any suitable manner.

As can be seen in FIGS. 2 and 3, the internal mechanisms of the modules 110, 120, 130 may be interconnected through various couple arms 210A-210D and various corresponding slots 220A-220E which will be described in greater detail below. The couple arms and slots may have any suitable shapes and configurations and it is noted that the shapes and configurations described herein are merely exemplary. In one embodiment, the coupling arms 210B, 210C, 210D and slots 220A, 220C, 220E of the interface module 120 may be configured to interconnect the internal mechanisms of the modules 110, 130 where a signal transmission axis of one or more actuation members of the modules 110, 130 are not collinear when the modules 110, 130 are arranged in a tandem assembly. In alternate embodiments, the coupling arms 210B, 210C, 210D and slots 220A, 220C, 220E of the interface module 120 may be arranged to interconnect collinear actuation members of the modules 110, 130. In one embodiment, coupling arms 210B, 210C, 210D of the interface module 120 that are not used when interfacing a circuit breaker module 110 with an accessory module 130 may be easily removed from, broken off, or otherwise recessed within the interface module by an operator so as not interfere with a housing of one or more of the circuit breaker module 110 and the accessory module 130 when the tandem circuit breaker 100 is assembled.

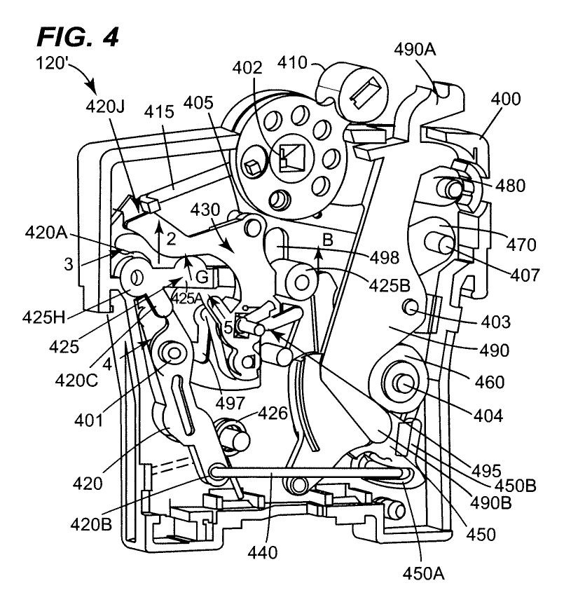

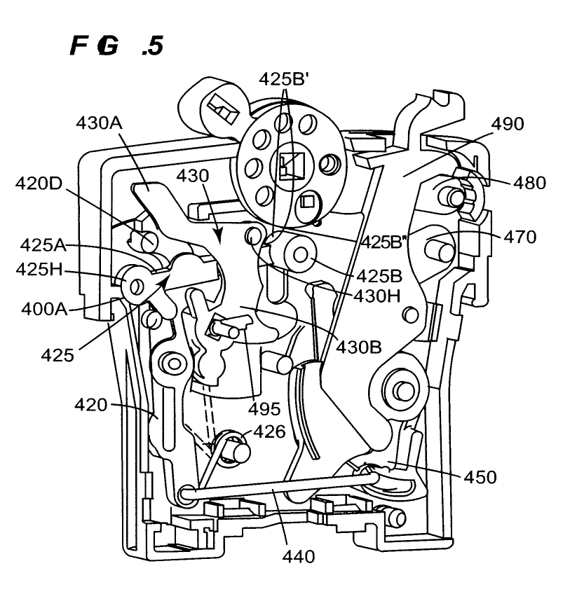

Referring now to FIGS. 4 and 5, one embodiment of an interface module 120′ will be described. In one embodiment, the interface module 120′ may be a passive interface in that resetting and tripping of the circuit breaker/accessory is performed in a respective one or more of the circuit breaker and accessory. In alternate embodiments the interface 120′ may include a retention mechanism for holding the interface in either an on or off configuration.

In this embodiment, the interface module 120′ includes housing 400, a first coupling assembly 425 and a second coupling assembly 430. The housing 400 may have any suitable shape and may be constructed of any suitable material. The housing 400 may include protrusions or axles 401-407 for supporting various elements of the interface module 120′. The axles 401-407 may be formed integrally with the housing 400 or they may be suitably inserted and secured in the housing in any suitable manner.

The first coupling assembly 425 may include a first couple arm 425B, a first translator lever 425A and a first translator hub 425H. The translator lever 425A connects the couple arm 425B and the translator hub 425H. The translator hub may be pivotally supported within the housing by for example, a recess 400A or any suitable axle similar to axles 401-407. A leg 425C may extend from, for example, the translator lever 425A and/or the translator hub 425H to reciprocally interact with an auxiliary lever 420. The first translator lever 425A may be interposed between auxiliary lever 420 and a second translator lever 430A of the second coupling assembly 430. The first couple arm 425B may at least partially extend into and travel along slot 498. It is noted that in one embodiment, slot 498 may be present on both sides of the interface module 120′. For example, the first couple arm 425B may include a first and a second opposing couple arm 425B′, 425B″ where each of the opposing arms 425B′, 425B″ extend at least party into corresponding slots on one or more sides of the housing 400 to interact with one or more of the modules 110, 130. In one embodiment, one or more of the first and second opposing arms 425B′, 425B″ may be configured to be easily removable by an operator.

The second coupling assembly 430 may include a second translator lever 430A, a second translator hub 430H, a translator arm 430B and a second couple arm 495 supported by the translator arm 430B. The hub 430H may be pivotally supported in the housing in any suitable manner such as by axle 405. The translator lever 430A may be configured to reciprocally interact with protrusion 420D of the auxiliary lever 420. The second couple arm 495 may at least partially extend into or through any suitable slot(s) such as, for example, slot 497 for interacting with modules 110, 130. In one embodiment, the second couple arm 495 may include first and second opposing arms 210B, 210D (FIGS. 2 and 3) that may extend through a respective slot in one or more sides of the interface module 120 for interacting with modules 110, 130. In one embodiment, one or more of the first and second opposing arms 210B, 210D may be configured to be easily removable by an operator. As shown in the Figures, the first and second coupling arms and their respective slots may be spaced apart from one another in, for example, a non-collinear manner. In alternate embodiments, the first and second coupling arms may have any suitable spatial relationship.

The auxiliary lever 420 may be pivotally supported in the housing 400 in any suitable manner such as by axle 401. The auxiliary lever 420 may be configured as described above for reciprocally communicating with the first and second coupling assemblies 425, 430. The auxiliary lever 420 may have a first end in communication with a handle lever 415 which allows a transfer of force between the auxiliary lever 420 and the handle 410. A second end of the auxiliary lever 420 may communicate with a resilient biasing member, such as spring 426. The spring may be supported within the housing in any suitable manner, such as by axle 406 and be configured to amplify movement of the auxiliary lever 420 and/or any forces transmitted through the auxiliary lever 420. The second end of the auxiliary lever 420 may also include an aperture 420B for rotatably accepting a connecting member or rod 440. In alternate embodiments the connecting rod 440 may be coupled to the auxiliary member in any suitable manner.

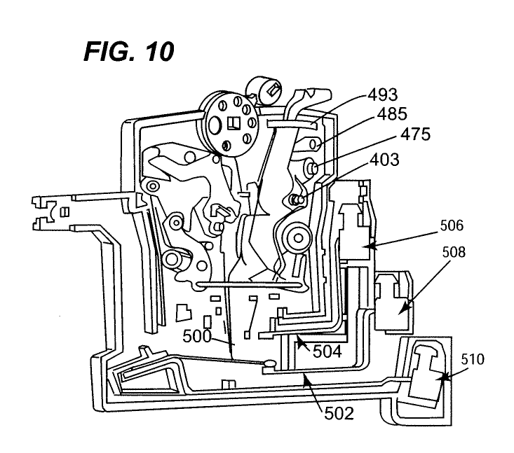

The connecting rod 440 may be any suitable connecting member for communicably coupling the auxiliary member with member 450. Member 450 may include a suitable slot 450A for accepting the connecting rod 440. As can be seen in the Figures the slot may be arcuate in shape but in alternate embodiments the slot may have any suitable shape. The member 450 may be pivotally supported in the housing in any suitable manner, such as by axle 404. Member 460 may also be supported by axle 404 and may interact with member 450. In an optional embodiment, member 460 may be configured to rotate lever 500 to actuate normally opened (NO) and normally closed (NC) contacts at bottom side as shown in FIG. 10 and described in more detail below. The interface module 120′ may also include reset assist member 490 pivotally supported within the housing 400 by, for example, axle 403. The reset assist member may be manipulated with handle portion 490A to pivot about axle 403 so reset arm 490B contacts protrusion 450A of member 450 causing member 450 to rotate. Member 450 may pull on connecting rod 440 causing auxiliary lever 420 to rotate releasing, for example, the biasing force exerted on one or more of the first and second coupling assemblies 425, 430 by the auxiliary lever 420. The interface 120′ may also include member 470 pivotally supported by axle 407 and member 480.

It will be understood that the interface module 120′ may be modified for use with any of the various auxiliary devices, for example, an auxiliary contact, signal contact, shunt trip, motor operator, panel board switch, and under voltage release. As shown in FIG. 10, other examples include an auxiliary which provides the status of protection device whether it is open or closed and an auxiliary which provides the status of a protection device whether it is open or closed and also provides a signal contact.

Referring now to FIG. 10, members 475, 485 and 493 and a spring (not shown), which may be located adjacent to member 475, may be provided to achieve a signal function in another optional embodiment. Also provided are a normally open (NO) contact 502 and a normally closed (NC) contact 504 along with wire terminals 506, 508 and 510. When used as a signal contact, the interface module 120′ may provide, among other things, information about the automatic tripping of protection devices, overload or short circuit for mini circuit breakers, and earth leakage tripping of RCD's. A test button (not shown) may be provided to simulate a function such as a status provision or signaling. Also, there may be a reset button for the contacts and a tripping signal (not shown).

Referring back to FIGS. 4 and 5, an exemplary operation of the interface module 120′ is described where the interface is activated through a force suitably exerted on, for example, couple arm 495 by one or more of the modules 110, 130. The force exerted on couple arm 495 may be exerted in the direction of arrow 5 which causes the second coupling assembly 430 to rotate in the direction of arrow 1. The second translator lever 430A is caused to move in the direction of arrow 2 which de-latches the interface module by pushing lever 415 at ball point 420J and the handle 410 will rotate because of a handle return spring 426 below it to turn the handle to an off position. In turn, the force given by lever 415 on ball point 420J releases which allows the biasing force of, for example, spring 426 to move the first end of the auxiliary member in the direction of arrow 3 (it is noted that protrusion 420D of the auxiliary member 420 may ride along second translator lever 430A). Protrusion 420C of the auxiliary member is caused to move in the direction of arrow 4. The movement of the protrusion 420C causes the rotation of the first coupling assembly 425 about hub 425H, through interaction between the protrusion 420C and leg 425C, thereby moving the first coupling arm 425B in the direction of arrow 6 to effectively transfer the amplified force originating from the second couple arm 495, where the force is amplified by, for example, the biasing member 426 acting through the auxiliary lever 420. Movement of the auxiliary member 420 also pushes rod 415 to rotate handle 410 to the off position as shown in FIG. 5. Movement of member 430 rotates and pushes in the direction of arrow 2 to member 415 to de-latch the interface module and spring below the handle 410 will rotate handle 410 to an off position as shown in FIG. 5.

Still referring to FIGS. 4 and 5 an exemplary operation of the interface module 120′ will be described where the interface is activated through a force suitably exerted on, for example, couple arm 425B by one or more of the modules 110, 130. In this example, the interface 120′ will be switched from an on position shown in FIG. 4 to an off position shown in FIG. 5. The force exerted on couple arm 425B may be exerted in the direction of arrow 6 which causes the first coupling assembly 425 to move or rotate in the direction of arrow G. The first translator lever 425A pushes on the second translator lever 430A causing the second coupling assembly to rotate in the direction of arrow 1. Movement of member 430 rotates and pushes in the direction of arrow 2 to member 415 to de-latch the interface module and the spring 426 below the handle 410 will rotate handle 410 to the off position as shown in FIG. 5 thereby allowing the auxiliary member 420 to rotate about axle 401 in the direction of arrows 3 and 4 in a manner substantially similar to that described above. The movement of the protrusion 420C of the auxiliary member 420 and/or the movement of the first translating lever 430A causes movement of the second coupling arm 495 in the direction of arrow 5 through the rotation of the second coupling assembly 430 to effectively transfer the force originating at couple arm 425B. Movement of the auxiliary member 420 also pushes rod 415 to rotate handle 410 to the off position as shown in FIG. 5. In the embodiment of FIG. 10, NO and NC contacts, 502, 504 are, in turn, actuated. In an on position of FIG. 4, lever 500 will push contact with NO contact 502. In an off position of FIG. 5, lever 500 will release and contact with NC contact 504.

As can be seen from the operation of the interface, the first translation lever 425A is configured to be responsive to movement by the auxiliary lever 420, the second translator lever 430A is configured to be responsive to movement by the first translator lever 425A and the auxiliary lever 420 is configured to be responsive to movement by the second translator lever 430A. The interaction between the first translator 425A, the auxiliary lever 420 and the second translator lever 430A allows for an effective transfer of force signals from one module 110, 120 to another module 110, 120. Because each of the auxiliary lever 420, the first coupling assembly 425 and the second coupling assembly 430 are all configured to be responsive to the movement of one or more of the other ones of the auxiliary lever 420, the first coupling assembly 425 and the second coupling assembly 430, the forces or signals transferred between couple arm 495 and couple arm 425B may also be amplified by biasing member 426.

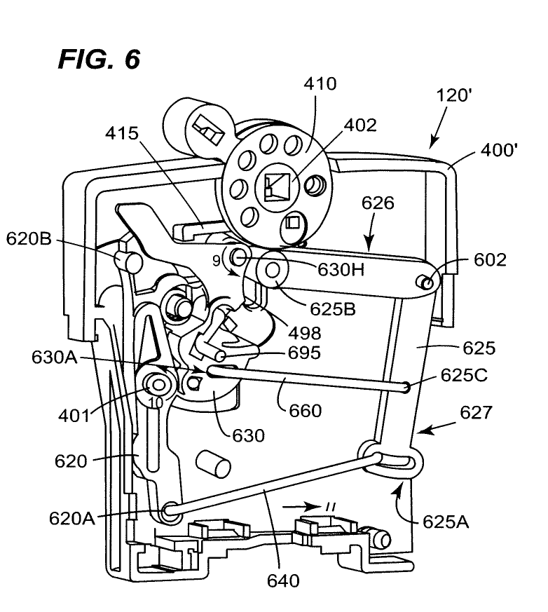

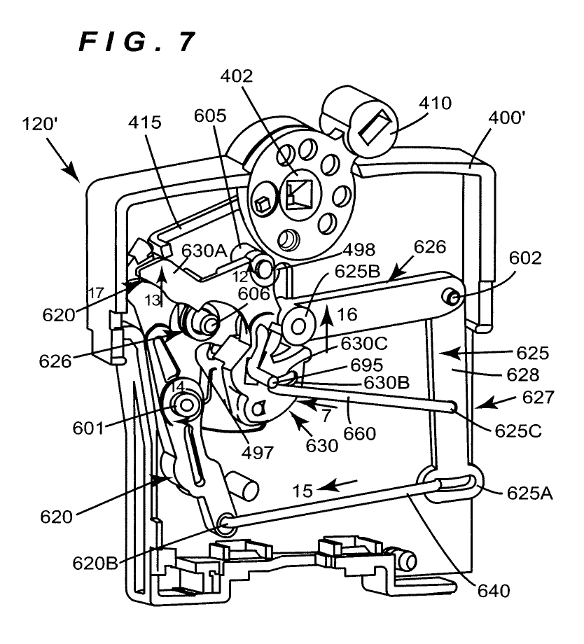

Referring now to now to FIGS. 6 and 7 another embodiment of an interface module 120′ will be described. In this embodiment the interface module includes housing 400′, a first coupling assembly 625 and a second coupling assembly 630. The housing 400′ may be substantially similar to housing 400 described above. The housing 400′ may include protrusions or axles 601, 602, 605, 606 for supporting various elements of the interface module 120′. The axles 601, 602, 605, 606 may be substantially similar to those described above with respect to FIGS. 4 and 5.

The first coupling assembly 625 may include a first translator lever 628. The first translator lever 628 may include a first translator leg portion 626, a first translator arm portion 627, a first couple arm 625B connected to the leg portion 626 and a connector 625A connected to the arm portion 627. The translator lever 628 may be pivotally supported within the housing by for example, axle 602. The first couple arm 625B may be substantially similar to couple arm 425B described above.

The second coupling assembly 630 may include a second translator lever 630A, a second translator hub 630H, a second translator arm 630B and a second couple arm 695 supported by the translator arm 630B. The second couple arm 695 may be substantially similar to couple arm 495 described above. The hub 630H may be pivotally supported in the housing in any suitable manner, such as by axle 605. The translator lever 630A may be configured to reciprocally interact with protrusion 620D of the auxiliary lever 620 in a manner substantially similar to that described above with respect to FIGS. 4 and 5.

The auxiliary lever 620 may be pivotally supported in the housing 400′ in any suitable manner such as by axle 601. The auxiliary lever 620 may be substantially similar to auxiliary lever 420 described above and be configured to reciprocally communicate with the first and second coupling assemblies 625, 630. However, in this example the first end of the auxiliary lever 620 may communicate with a resilient biasing member, such as spring 626. The spring may be supported within the housing in any suitable manner, such as by axle 606 and be configured along with the auxiliary lever 620 to amplify movement of the auxiliary lever 620 and/or any forces transmitted through the auxiliary lever 620. The second end of the auxiliary lever 620 may include an aperture 620B for rotatably accepting a connecting member or rod 640. In alternate embodiments the connecting rod 640 may be coupled to the auxiliary member in any suitable manner.

The connecting rod 640 may be substantially similar to rod 440 described above however in this example, the connecting rod 640 connects the auxiliary member 620 with the first translator lever 628 through connector 625A. The connector 625A may include, for example, a slot having any suitable shape including, but not limited to, the arcuate shape shown in the Figures for allowing a sliding connection between the connecting rod 640 and the connector 625A. The slot in the connector 625A may allow for a releasing of the load on the first coupling assembly 625 while resetting or turning the one or more of the modules 110, 120′, 130 to an on position.

In this embodiment, a second connecting rod 660 is provided to suitably connect the first and second coupling assemblies 625, 630. The second connecting rod 660 may assist in resetting the tripped assembly 100. In one example, a first end of the second connecting rod 660 may slidingly connect to the second translator arm 630B in any suitable manner, such as by aperture 630C. The aperture 630C may have any suitable configuration including, but not limited to, the arcuate slot shape shown in the Figures. The slot 630C may allow for a releasing of the load of the first coupling assembly 625 during a tripping of one or more of the modules 110, 120′, 130. A second end of the connecting rod 660 may be rotatably coupled to the arm portion 627 of the first coupling assembly 625 in any suitable manner such as through, for example, aperture 625C.

Still referring to FIGS. 6 and 7 the operation of the interface module 120′ will now be described where the interface is activated through a force suitably exerted on, for example, couple arm 695 by one or more of the modules 110, 130. In this example, the interface 120′ will be switched from an on position shown in FIG. 7 to an off position shown in FIG. 6. In this example, a force is exerted on the couple arm 695 by one or more of the modules 110, 130 such that the second coupling assembly is rotated in the direction of arrow 12 which in turn causes the translator lever 630A to move in the direction of arrow 13. Movement of member 630 rotates and pushes in the direction of arrow 13 to member 415 to de-latch the interface module and the spring 626 below the handle 410 will rotate handle 410 to the off position as shown in FIG. 6. As described above, movement of the translator lever 630A may allow the biased auxiliary lever 620, whose movement and forces (e.g. signals) are amplified by the spring 626, to rotate in the direction of arrow 14. The rotation of the auxiliary lever 620 causes the second end of the lever to pull the connecting rod 640 and the connector 625A in the direction of arrow 15 resulting in a rotation of the first coupling assembly 625 about axle 602. Rotation of the first coupling assembly 625 causes the couple arm 625B to move in the direction of arrow 16 to effectively transfer a signal input from one of the modules 110, 130 at couple arm 695 to another one of the modules 110, 130 through couple arm 625B. Because, each of the auxiliary lever 620, the first coupling assembly 625 and the second coupling assembly 630 are all configured to be responsive to the movement of one or more of the other ones of the auxiliary lever 620, the first coupling assembly 625 and the second coupling assembly 630, the forces or signals transferred between couple arm 695 and couple arm 625B may also be amplified by biasing member 626. It is noted that rotation of the handle 410 in the example may be performed in a substantially similar to that described above with respect to FIGS. 4 and 5.

Still referring to FIGS. 6 and 7 an exemplary operation of the interface module 120′ will be described where the interface is activated through a force suitably exerted on, for example, couple arm 625B by one or more of the modules 110, 130. In this example, the interface 120′ will be switched from an on position shown in FIG. 7 to an off position shown in FIG. 6. In this example the force on couple arm 625B may cause the couple arm 625B to move in the direction of arrow 16 thereby causing rotation of the first coupling assembly 625 about axle 602. Rotation of the first coupling assembly 625 pushes or otherwise causes the second connecting rod 660 to move in the direction of arrow 7. Movement of the connecting rod 660 in the direction of arrow 7 causes rotation of the second coupling assembly 630 in the direction of arrow 12. Movement of member 630 rotates and pushes in the direction of arrow 13 towards member 415 to de-latch the interface module and the spring 626 below the handle 410 will rotate handle 410 to the off position as shown in FIG. 6. The rotation of the second coupling assembly 630 also causes movement of the second couple arm 695 for transfer of the force or signal input at couple arm 625B. The signal may be amplified through a rotation of the auxiliary lever 620 and the interaction between protrusion 620D and the translator lever 630A of the first coupling assembly 630 as described above. In this configuration, the NO/NC contact, shown in FIG. 10, will not be present and, it will be appreciated that the interface module 120′ may omit any auxiliary function.

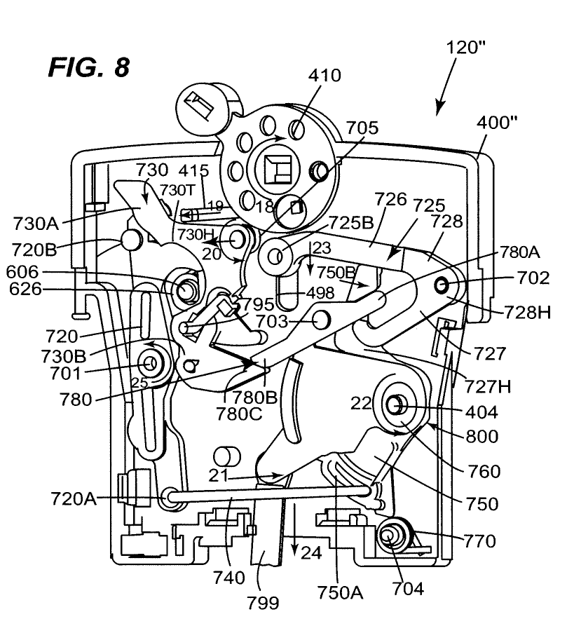

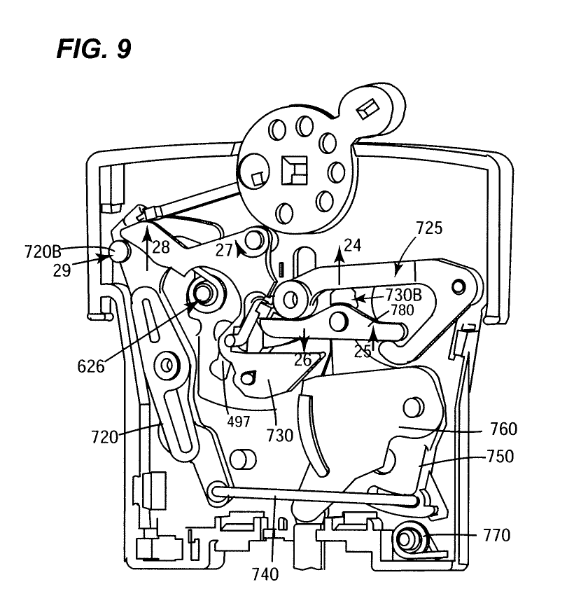

Referring now to FIGS. 8 and 9 yet another embodiment of an interface module 120″ will be described. In this embodiment the interface module 120″ includes housing 400″, a first coupling assembly 725 and a second coupling assembly 730. The housing 400″ may be substantially similar to housing 400 described above. The housing 400″ may include protrusions or axles 606 and 701-705 for supporting various elements of the interface module 120″. The axles 606 and 701-705 may be substantially similar to those described above with respect to FIGS. 4 and 5.

The first coupling assembly 725 may include a first translator lever 728. The first translator lever 728 may include a first translator hub portion 728H that is pivotable about axle 702, a first translator leg portion 726 extending from the hub portion 728H and supporting the first couple arm 725B, and a translator arm portion 727 extending from the hub portion 728H. The first couple arm 725B may be substantially similar to the couple arm 425B described above with respect to FIG. 4. The arm portion 727 in this example is configured to include a hook portion 727H. In alternate embodiments the first translator lever may have any suitable configuration. The extended end 750B of the biased pivot assembly 800 serves to further amplify the forces/movement of the auxiliary lever 720 acting on the second coupling assembly 730.

A T-lever 780 may be pivotally supported about axle 703. The axle may be configured for accepting a cir-clip (circular clip) or snap ring for holding the T-lever on the axle 703. The T-lever 780 may have a first end 780A for communicating with the hook portion 727H of the first translator lever 728 and a second end 780B for communicating with a hand portion 730C of a second translator lever. The T-lever 780 allows for the transfer of force signals from the first coupling assembly 725 to the second coupling assembly 730 during, for example, a tripping of the circuit breaker assembly 100.

The second coupling assembly 730 may include the second translator lever 730T, a second translator hub portion 730H, a second translator leg 730A extending from the hub portion 730H, a second translator arm 730B and a second couple arm 795 supported by the translator arm 730B. The second couple arm 795 may be substantially similar to couple arm 495 described above with respect to FIG. 4. The second translator hand 730C extends from the translator arm 730B for communicating with the T-lever 780. The hub 730H may be pivotally supported in the housing in any suitable manner such as by axle 705. The translator leg 730A may be configured to reciprocally interact with protrusion 720B of the auxiliary lever 720 in a manner substantially similar to that described above with respect to FIGS. 6 and 7. The second couple arm 695 may be substantially similar to couple arm 495 described above.

The auxiliary lever 720 may be pivotally supported in the housing 400″ in any suitable manner such as by axle 701. The auxiliary lever 720 may be substantially similar to auxiliary lever 620 described above and be configured to reciprocally communicate with at least one of the first and second coupling assemblies 725, 730. In this example a first end of the auxiliary lever 720 may communicate with first resilient biasing member, such as spring 726. The spring may be supported within the housing in any suitable manner, such as by axle 606 and be configured to amplify movement of the auxiliary lever 720 and/or any forces transmitted through the auxiliary lever 720. A second end of the auxiliary lever 720 may include an aperture 720A for rotatably accepting a connecting member or rod 740. In alternate embodiments the connecting rod 740 may be coupled to the auxiliary member in any suitable manner. The connecting rod 740 connects the auxiliary member 720 to a biased pivot assembly 800, which may further amplify the movement of the auxiliary lever 720 and forces transmitted by the auxiliary lever 720.

The biased pivot assembly 800 may include a first member 750 including, for example, a slot 750A having any suitable shape including, but not limited to, the arcuate shape shown in the Figures for allowing a sliding connection between the first member 750 and the rod 740. The slot 750A in member 750 may allow for a releasing of the load on one or more of the first and second coupling assembly 725, 730 during, for example, a tripping of one or more of the modules 110, 120″, 130. A resilient member, such as spring 770 supported on, for example, axle 704 may exert a biasing force on member 750, which force is transferred to the auxiliary lever 720 through rod 740. In alternate embodiments the force exerted by spring 770 may be transferred to, for example, the auxiliary lever 720 and/or one or more of the first and second coupling assemblies in any suitable manner. A second member 760 may be communicably coupled with the first member 750 in any suitable manner. The first and second members 750, 760 may be pivotally supported by axle 404. An assist lever 799 may be pivotally connected to the second member 760 in any suitable manner.

The assist Lever 799 may be provided to push NO/NC contacts such as those shown in FIG. 10 and described above. The rotation of the first member 750 of the biased pivot assembly 800 may allow the connecting rod 740 to slide in slot 750A to release a bias force exerted by spring 770 on connecting rod 740 through the first member 750. As can be seen in FIG. 8, rotation of the handle 410 causes extension of rod 415 in the direction of arrow 19 which in turn may cause a rotation of the auxiliary lever 720 and the second coupling assembly 730 in the directions of arrows 25, 20 respectively as well as the movement of the first coupling arm in the direction of arrow 23 for the resetting of the interface 120″. In alternate embodiments, the first and second coupling assemblies 725, 730 may be rotated through interaction with one or more of the modules 110, 130 through movement of, for example, the commonly connected handles 250, 420, 310 as described above with respect to FIGS. 2 and 3.

Still referring to FIGS. 8 and 9 will be described where the interface is activated through a force suitably exerted on, for example, couple arm 725B by one or more of the modules 110, 130. In this example, the interface 120″ will be switched from an on position shown in FIG. 9 to an off position shown in FIG. 8. In this example, a force may be suitably exerted on the first couple arm 725B so that the couple arm 725 is urged in the direction of arrow 24 which causes a rotation of the first translator lever 728 about axle 702. The hook portion 727H of the first translator lever 728 pushes on the first end 780A of the T-lever 780 in the direction of arrow 25, which causes rotation of the T-lever about axle 703. The second end 780B of the T-lever 780 pushes on the hand portion 730C of the first coupling assembly in the direction of arrow 26 causing a rotation of the second coupling assembly 730 in the direction of arrow 27. Rotation of the second coupling assembly 730 translates the second coupling arm 795 in, for example, slot 497 to transfer the force to one or more of the modules 110, 130. Second translator leg 730A pushes rod 415 to trip the interface module from on to off position during this transferring the force to 110, 130. The force transferred by coupling arm 795 is amplified through the amplified movement of the auxiliary lever 720. As the second coupling assembly is rotated the auxiliary lever 720 is also allows to rotate through the biasing forces of spring 626 and spring 770 so that protrusion 720B pushes on the second translator leg 730A for transferring the biasing forces to the second coupling assembly 730 for force signal amplification. In the reverse direction a force transmission from the second coupling arm 795 to the protrusion 720B through the aperture 720A with the spring 770 pushing extended end 750B pushing couple arm 725, in turn, first couple arm 725B in the direction of arrow 23 while getting amplification from spring 626.

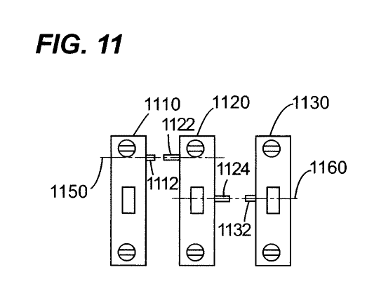

Referring now to FIG. 11, each of a first circuit 1110 and a second circuit 1130 may be disposed about an interface module 1120 configured in accordance with another embodiment of the present invention. Each of the first circuit 1110 and the second circuit 1130 may be configured, for example, as a circuit breaker, circuit assembly or any other electrical device such as described above.

The interface module 1120 comprises a first couple arm 1122 for transmitting a signal received from the second circuit 1130 to the first circuit 1110 and, in the inverse, a second couple arm 1124 for transmitting a signal received from the first circuit to the second circuit. One exemplary signal may be a short circuit condition identified by the first circuit 1110, e.g., embodied as a circuit breaker that requires the tripping of the second circuit 1130 which is also, e.g., embodied as a circuit breaker. Axes of force/signal transmission 1150 and 1160 are shown which are non-aligned, non-collinear axes.

As illustrated, the first circuit 1110 comprises an output couple arm 1112 and the second circuit 1130 also comprises an output couple arm 1132 each for outputting a signal to the interface module 1120. It will be understood that the interface module 1120 may optionally be configured to carry out any suitable auxiliary function for example, such as that of a signal contact, a shunt trip, a motor operator, a panel board switch and a under voltage release. In this way, the interface module 1120 may be configured such that at an appropriate juncture each of the first and second couple arms 1122 and 1124 may output the same signal to each of the first and second circuits 1110 and 1130. One appropriate juncture may be upon a short circuit condition of the interface module 1120 where it is necessary to trip both the first and second circuits 1110 and 1130.

It is noted that the systems and operations of the disclosed embodiments are exemplary in nature and that the disclosed embodiments may have any suitable components for carrying out the operations described herein. The configuration of the components of the interface modules described herein are also exemplary and it should be understood that the components may have any suitable shapes, sizes and/or configuration. For example, the interface module may include any suitable force transmission/amplification mechanism including, but not limited to, those described above as well as any suitable gear trains or any combination thereof. It is also noted that the features of the disclosed embodiments may be used individually or in any suitable combination.

Technical effects of the herein described systems and methods include transferring force signals and displacements in non-collinear axes, as well as in more than one locus, between a first circuit device and a second circuit device. Other technical effects include an amplification of the force signals as they are transferred between the first circuit device and the second circuit device. A reduction in toggle force for switching the first and second electrical devices between on and off positions may also be realized through the disclosed embodiments.

The disclosed embodiments provide a side-by-side or tandem circuit breaker arrangement where a circuit breaker and an accessory are joined by an interface. The interface is configured to allow force transmission between the circuit breaker to the accessory when the transmission axes of the circuit breaker and accessory are dissimilar. The interface of the disclosed embodiments is also configured to amplify the force signal transmitted between the circuit breaker and accessory.

While embodiments have been described in connection with what are presently considered to be the most practical and preferred embodiments, it is to be understood that the embodiments are not limited to those disclosed herein. Rather, the embodiments described are intended to cover all of the various modifications and equivalent arrangements included within the spirit and scope of the appended claims.

What is claimed is:

1. An interface module configured for transmitting a status change signal between a first circuit device having a first circuit device couple and a second circuit device having a second circuit device couple, the interface module comprising:
a housing;
a first coupling assembly comprising a first couple arm; and
a second coupling assembly comprising a second couple arm;
wherein each of the first and second couple arms extends through the housing at a location that is spaced from the other, each of the first and second coupling assemblies is movable by the first circuit device couple and/or the second circuit device couple to transmit a status change signal there between.

2. The device of claim 1, wherein each of the first and second couple arms is movable in an angular and/or a linear direction.

3. The device of claim 1, wherein the first circuit device comprises at least one of a circuit assembly, a panel board switch, motor operator, contact auxiliary, a circuit breaker, a shunt trip, under voltage release and the second circuit device comprises at least one of a miniature circuit breaker, a residual current circuit breaker, residual current device, and a residual current circuit breaker with over current protection.

4. The device of claim 1, further comprising an auxiliary lever supported by the housing and wherein the first and second coupling assemblies comprises a respective first and second translator lever.

5. The device of claim 4, wherein the first translator lever is interposed between the auxiliary lever and the second translator lever and wherein the first translator lever is configured to be responsive to movement by the auxiliary lever, the second translator lever is configured to be responsive to movement by the first translator lever and the auxiliary lever is configured to be responsive to movement by the second translator lever.

6. The device of claim 5, wherein the auxiliary lever is biased to amplify movement thereof.

7. The device of claim 4, wherein the second translator lever comprises:
a second translator hub that is pivotable; and
a second translator arm portion extending from the second translator hub and supporting the second couple arm.

8. The device of claim 1, wherein each of the first and second couple arms comprise a respective first and second opposing couple arms and each of the first and second couple arms and each of the first and second opposing couple arms are configured to be easily removable by an operator.

9. The device of claim 7, wherein the first translator lever comprises:
a first translator hub portion that is pivotable;
a first translator leg portion that extends from the first translator hub portion and that supports the first couple arm; and
a first translator arm portion that extends from the first translator hub portion and that is connected to the auxiliary lever and the second translator lever via a pair of connecting rods.

10. The device of claim 9, wherein each of the first and second translator arm portions comprises a connecting arm slot wherein a connecting arm is slideably mounted.

11. The device of claim 7, wherein the first translator lever comprises:
a first translator hub portion that is pivotable;
a first translator leg portion extending from the first translator hub portion that supports the first couple arm; and
a first translator arm portion extending from the first translator hub portion and comprising a hook portion that is interconnected with the auxiliary lever via a biased pivot assembly and a connecting rod and with the second translator lever via a T-lever.

12. The device of claim 11, wherein the biased pivot assembly comprises a connecting arm slot wherein a connecting arm is slideably mounted.

13. The device of claim 12, wherein:
the second translator lever comprises a second translator hand portion; and
the T-lever comprises a first shoulder engageable with the first translator hook portion and a second shoulder engageable with the second translator hand portion.

14. A circuit assembly, comprising:
a first circuit device having a first circuit couple;
a second circuit device having a second circuit device couple; and
an interface module adjacent to the first circuit device and the second circuit device, the interface module comprising:
a housing;
a first coupling assembly comprising a first couple arm; and
a second coupling assembly comprising a second couple arm;
wherein each of the first and second couple arms extends through the housing at a location that is spaced from the other, each of the first and second coupling assemblies is movable by the first circuit device couple and/or the second circuit device couple to transmit a status change signal there between.

15. The circuit assembly of claim 14, wherein the first circuit device and the second circuit device each comprise an output couple arm.

16. The circuit assembly of claim 14, wherein each of the first and second couple arms is movable in an angular and/or a linear direction.

17. The circuit assembly of claim 14, wherein the first circuit device comprises at least one of a circuit assembly, a panel board switch, motor operator, contact auxiliary, a circuit breaker, a shunt trip, under voltage release and the second circuit device comprises at least one of a miniature circuit breaker, a residual current circuit breaker, residual current device, and a residual current circuit breaker with over current protection.

18. The circuit assembly of claim 14, further comprising an auxiliary lever supported by the housing and wherein the first and second coupling assemblies comprises a respective first and second translator lever.

19. The circuit assembly of claim 18, wherein the first translator lever is interposed between the auxiliary lever and the second translator lever and wherein the first translator lever is configured to be responsive to movement by the auxiliary lever, the second translator lever is configured to be responsive to movement by the first translator lever and the auxiliary lever is configured to be responsive to movement by the second translator lever.

20. The circuit assembly of claim 18, wherein the second translator lever comprises:
a second translator hub that is pivotable; and
a second translator arm portion extending from the second translator hub and supporting the second couple arm.

21. The circuit assembly of claim 14, wherein each of the first and second couple arms comprise a respective first and second opposing couple arms and each of the first and second couple arms and each of the first and second opposing couple arms are configured to be easily removable by an operator.

22. The device of claim 21, wherein the first translator lever comprises:
a first translator hub portion that is pivotable;
a first translator leg portion that extends from the first translator hub portion and that supports the first couple arm; and
a first translator arm portion that extends from the first translator hub portion and that is connected to the auxiliary lever and the second translator lever via a pair of connecting rods.

23. The device of claim 21, wherein the first translator lever comprises:
a first translator hub portion that is pivotable;
a first translator leg portion extending from the first translator hub portion that supports the first couple arm; and
a first translator arm portion extending from the first translator hub portion and comprising a hook portion that is interconnected with the auxiliary lever via a biased pivot assembly and a connecting rod and with the second translator lever via a T-lever.
